(19) United States
(12) Patent Application Publication
(10) Pub. No.: US 2003/0108114 A1
(43) Pub. Date: Jun. 12, 2003

(54) Method for interleaving data in packet-based communications and a system thereof

(75) Inventors: Mark F. Bocko, Caledonia, NY (US); James Trek, Brockport, NY (US)

Correspondence Address: Gunnar G. Leinberg, Esq., NIXON PEABODY LLP, Clinton Square, P.O. Box 31051, Rochester, NY, 14603, US

(73) Assignee: University of Rochester

(21) Appl. No.: 10/015,990

(22) Filed: Dec. 10, 2001

(51) Int. Cl. H04L 5/12; H04L 23/02

(52) U.S. Cl. 375/265; 714/756; 714/759; 714/760; 714/761

(57) ABSTRACT

A method for interleaving data in packet based communications includes interleaving elements of data in a source sequence to form an interleaved sequence and transmitting the interleaved sequence of the elements of the data. Adjacent elements of data in the interleaved sequence originally were separated by a first number of elements of data in the source sequence. Additionally, originally adjacent elements of data in the source sequence are separated by at least a second number of elements of data in the interleaved sequence.

### FIELD OF THE INVENTION

This invention generally relates to communication methods and systems and, more particularly, to a method and system for interleaving data in packet based communications.

### BACKGROUND OF THE INVENTION

Information, such as an audio stream, is sensitive to the loss of contiguous data. However, given the nature of an audio signal, if a limited number of nearby audio samples are lost, then interpolation may be used to mask these errors. Well-known techniques, such as the Cross-Interleaved Reed-Solomon Coding (CIRC) employed in audio CDs as disclosed in, “CIRC—The error correcting code for the compact disc digital audio system” by Vries, L. B. and Odaka, K in AES Digital Audio Collected Papers, Rye, 1983 which is herein incorporated by reference, have been developed to compensate for the loss of data in an audio stream. Unfortunately, CIRC is computationally intensive and it is static, i.e. it is not adaptable in real time to the nature of the errors.

With Internet communications, the most prevalent Internet communication protocol, TCP/IP, corrects for errors in the transmission of information by re-sending packets containing the information that is lost. Unfortunately, re-sending packets introduces an intolerable delay for real-time applications, such as full duplex audio. The Real-time Transport Protocol (RTP) and RTP Control Protocol (RTCP) provide a framework for real-time communication over an IP network, with specific provision for the recovery of lost data left to the application running on the end-user's platform. A major function of RTCP is to monitor the network during the transmission of real-time data and to provide the users information on network performance to allow their applications to correct for errors, either by changing the bandwidth of the transmission or re-sending lost data.

### SUMMARY OF THE INVENTION

A method for interleaving data in packet based communications in accordance with one embodiment of the present invention includes interleaving elements of data in a source sequence to form an interleaved sequence and transmitting the interleaved sequence of the elements of the data. Adjacent elements of data in the interleaved sequence originally were separated by a first number of elements of data in the source sequence. Additionally, originally adjacent elements of data in the source sequence are separated by at least a second number of elements of data in the interleaved sequence.

A computer readable medium having stored thereon instructions for communications using interleaving in accordance with another embodiment of the present invention which when executed by a processor, causes the processor to perform the steps of interleaving elements of data in a source sequence to form an interleaved sequence and transmitting the interleaved sequence of the elements of the data. Adjacent elements of data in the interleaved sequence originally were separated by a first number of elements of data in the source sequence. Additionally, originally adjacent elements of data in the source sequence are separated by at least a second number of elements of data in the interleaved sequence.

A system for interleaving data in packet based communications in accordance with one embodiment of the present invention includes a first interleaving processing system and a first communication system. The first interleaving processing system interleaves elements of data in a source sequence to form an interleaved sequence. Adjacent elements of data in the interleaved sequence originally were separated by a first number of elements of data in the source sequence. Additionally, originally adjacent elements of data in the source sequence are separated by at least a second number of elements of data in the interleaved sequence. The first communication system transmits the interleaved sequence of the elements of the data.

The present invention provides an improved packet based communication system and method through the use of interleaving which provides that any data lost in a stream of information is not lost from any one localized segment of that information. The present invention may be applied to data at the level of the bit, byte, or group of bytes depending upon the specific application. Further, the present invention enables this error compensation strategy to become a component of the user application and enables a minimal Internet communication protocol, such as UDP/IP, to be used.

The present invention is also a faster and more efficient alternative to prior error correction strategies, such as re-sending information when data is lost. The present invention operates in real time and eliminates the need for and the delay associated with re-sending lost data, either within the transfer control protocol (TCP) or RTP/RTCP. Additionally, the present invention is computationally simple and can be simply implemented. Further, the present invention is adaptable to the nature of the errors and may be changed “on the fly” in real-time applications. As a result, the present invention reduces network overhead and addresses quality and latency delay problems in current two-way audio and video communications.

### BRIEF DESCRIPTION OF THE DRAWINGS

FIG. 1 is a block diagram of a system for interleaving data in packet based communications in accordance with one embodiment of the present invention;

FIG. 2 is a graph of a conditional probability of losing a packet “n” when a packet “n−1 ” is lost as a function of the delay between the consecutive packets;

FIG. 3 is a flow chart of a method for packet based communications using interleaving in accordance with another embodiment of the present invention;

FIG. 4A is a diagram of an original sequence of packets for transmission which illustrates that the loss of packets P5 and P6 leads to the loss at a block of contiguous data;

FIG. 4B is a diagram of the de-interleaved received data following the loss of sequential packets containing interleaved data which illustrates that the lost audio data is now distributed throughout the data segment;

FIG. 5A is a graphical representation that enables one to visualize the effect of interleaving in which the new location of data in the data record is plotted as a function of its old location, shown is such a representation of the data prior to interleaving;

FIG. 5B is a graph of the location of interleaved data as a function of an original location in accordance with one example; and

FIG. 6 is a graph of interleaved data in a new location as a function of an original location in accordance with another example.

### DETAILED DESCRIPTION

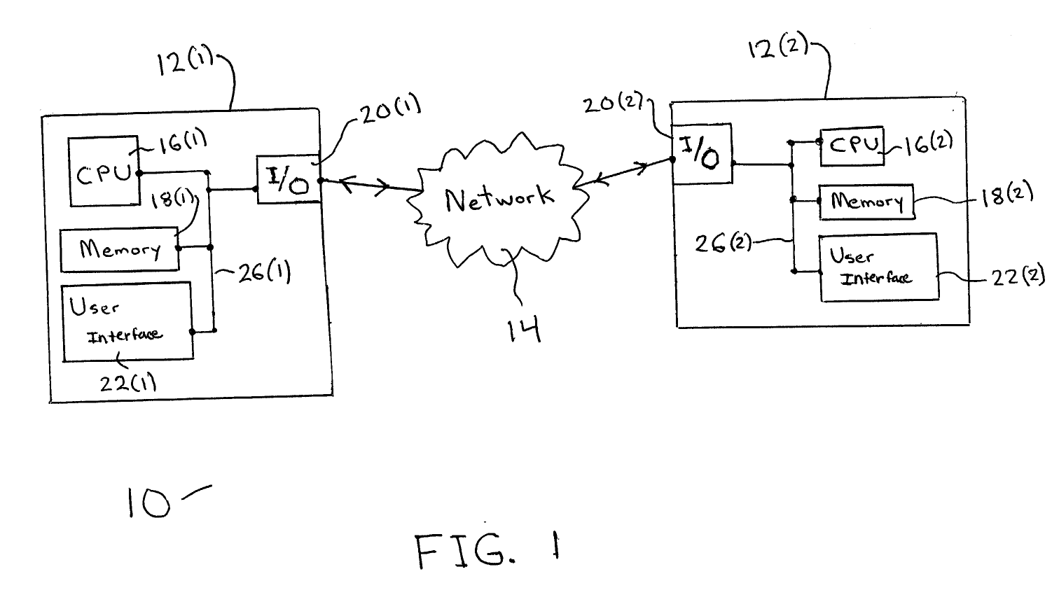

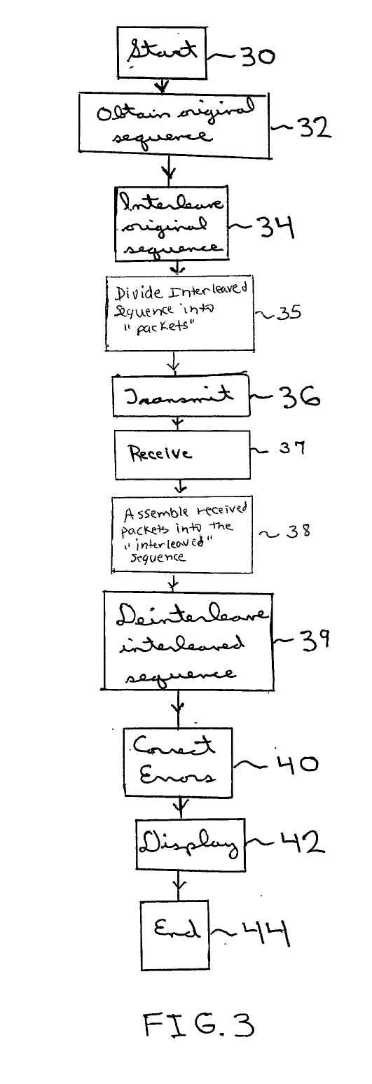

A system 10 and method for packet based communications which uses interleaving in accordance with one embodiment of the present invention are illustrated in FIGS. 1 and 3. In this particular embodiment, the system includes a pair of communication nodes 12(1) and 12(2) coupled together by network 14. The method includes the conversion of user input to data to a digital format, the arrangement of the data into interleaved packets of data that are sent over the network, the reception of the interleaved pockets of data on the receiving end, and conversion of the interleaved pockets of data back to a signal at the user interface. The present invention provides an improved packet based communication system 10 and method through the use of interleaving which provides that any data lost in a stream of information is not lost from any one localized segment of that information.

Each of the communication nodes 12(1) and 12(2) includes a central processing unit (CPU) or processor 16(1) and 16(2), a memory 18(1) and 18(2), an input/output interface 20(1) and 20(2), and a user interface 22(1) and 22(2), which are coupled together by a bus system or other link 26(1) and 26(2), respectively, although the communication nodes 12(1) and 12(2) may comprise other components, other numbers of the components, and other combinations of the components. The pair of communication nodes 12(1) and 12(2) shown in this particular embodiment, could be any of several types of communication systems or devices, such as cellular telephones, personal digital assistants, and facsimile machines coupled together in a variety of different fashions.

At least one of the processors 16(1) or 16(2) executes one or more programs of stored instructions for the method for packet based communications which uses interleaving in accordance with one embodiment of the present invention as described herein and illustrated in FIG. 3. In this particular embodiment, those programmed instructions are stored in one or more memories, such as memory 18(1) and/or memory 18(2) although some or all could be stored and retrieved from other locations. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for memory 18(1) and 18(2). Each of the input/output interfaces 20(1) and 20(2) is used to operatively couple and communicate between the communication nodes 12(1) and 12(2) via network 14. Each of the user interfaces 22(1) and 22(2) enables an operator to generate and transmit signals or commands to the CPUs 16(1) and 16(2), such as the desired spacing of the information for interleaving. A variety of different types of user interfaces 22(1) and 22(2) can be used, such as a keyboard or computer mouse.

In this particular embodiment, the communications network 14 couples the communication nodes 12(1) and 12(2) together. The specific network could be one of many types of communication networks, such as the Internet, a LAN, a WAN, or a wireless network, operating using a variety of different types of communication protocols.

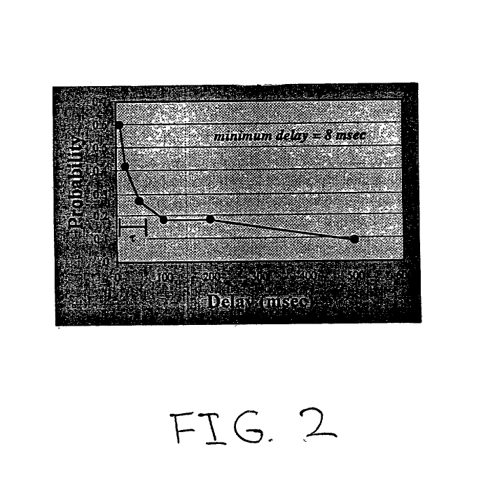

Through the employment of interleaveing, the present invention adjusts for the fact that in packet based communication networks, such as with system 10, the loss of packets is “bursty”, i.e., the probability of losing a packet or element is greater if the previous packet in a sequence is lost. The conditional probability P(n|n−1) of losing a packet, n, given the loss of the previous packet, n−1, in a sequence as a function of the time interval separating the transmission of two packets is discussed in, “End-to-End Packet Delay and Loss Behavior on the Internet,” by Bolot J. C. in SIGCOMM '9, p. 289 which is herein incorporated by reference. Referring to FIG. 2, the plotted data shows that for inter-packet delay less than 100 msec, the conditional probability increases dramatically. Accordingly once one packet is lost, there is a greater probability that the packet immediately following the lost packet will also be lost effecting the quality of the transmission.

Referring to FIG. 3, a method for interleaving in accordance with one embodiment of the present invention will be described. The present invention may be applied to packet-based communication of serial information, such as audio or video streams. In step 30, the method starts and then in step 32 an original sequence to be transmitted is obtained. The original sequence may be entered by an operator via a user interface 22(1) or 22(2) at one of the communication nodes 12(1) or 12(2) or may be obtained from other sources, such as being retrieved from memory 18(1) or 18(2). In step 34, the data is interleaved following the algorithms described herein.

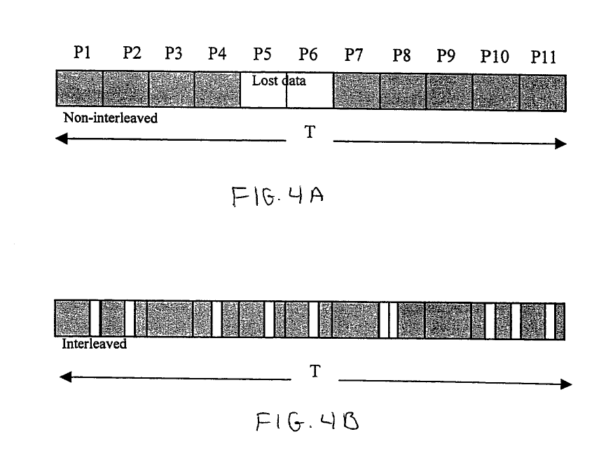

The value of interleaving in the face of burst errors is illustrated by FIGS. 4A and 4B. If the source sequence was not interleaved prior to transmission, then the loss of sequential packets in FIG. 4A, such as consecutive packets P5 and P6, would result in a loss of a large amount of contiguous data. If, however, the source sequence is interleaved prior to transmission, then the loss of packets P5 and P6 in FIG. 4B leads to a number of dispersed errors, in the de-interleaved sequence, each of limited time duration which can be more easily masked and is less damaging to quality.

A variety of different methods for interleaving can be used to achieve the following. Adjacent elements in the interleaved sequence are separated by a first number of elements in the original, non-interleaved, sequence. Furthermore, adjacent elements in the source sequence are separated by at least a second number of elements in the interleaved sequence. A common feature of the interleaving methods described herein are that the first element of data in the source sequence is also the first element of data in the interleaved sequence.

In accordance with one embodiment of the present invention, each of the communication nodes 12(1) and 12(2) are programmed to interleave a source sequence to produce an output file for serial transmission over a communication channel. Interleaving a source sequence or file means that the order of the elements in the interleaved sequence or file is a modification of the original order of elements in the source sequence. The modification sought is one that separates elements that are close to each other in the source file. Such separation aids data recovery because the loss of a string of elements in the transmission is then less likely to cause the loss of an entire local context.

The interleaving must not introduce more latency than is tolerable by the end users and must separate contiguous data sufficiently far apart in time to make the interleaving scheme effective given the network packet loss statistics. The additional latency introduced by the interleaving scheme is equal to the total duration of the data, (indicated by T in FIGS. 4A and 4B), plus the amount of time required to interleave and de-interleave the data plus the time required to mask any errors in the received sequence. In order for the interleaving to be useful it must separate adjacent data by a time interval of at least the width, ζ, of the conditional probability curve shown in FIG. 2.

In the interleaving method, the first element of the source sequence, S, is copied to the first space of the output or interleaved sequence, O, and then a given number of elements in the source sequence are skipped to reach another element of the source sequence. This element of the source sequence is then copied to the second location in the interleaved sequence. This process is repeated and each time that the end of the source sequence is reached, the process is begun again at the start of the remaining elements of the source sequence as if the elements of the source file were arranged in a circular buffer.

With respect to the interleaving processes described herein, as described above S is the source or input sequence and O is the interleaved sequence. Additionally, D is the de-interleaved sequence, S(h) is a specific element in the input sequence, O(i) is a specific element in the interleaved sequence, and D(h) is a specific element in the de-interleaved sequence.

N is the number of elements to be interleaved and it is always a whole number. N should be greater than four and there is no upper limit on the size of N.

K is the number of elements routinely skipped after each time that an element is copied from the source sequence to the interleaved sequence. The skip, K, must be a whole number greater than one. The interleaving may sometimes require a skip of K+1 elements rather than K elements. Whatever the values of N or K, J*K+L=N, where J is a whole number greater than 1 and L is any non-negative integer less than J and less than K.

By way of example only, if J=2, K=2, L=1, and N=5 and the source sequence contains elements S(0) through S(4) the interleaved sequence will contain elements O(0) through O(4) in an order specified by the interleaving. Since the interleaving will affect only the placement of the respective elements we may simplify our notation by labeling an element by its position in S. In other words, the interleaving process takes as input the numbers 0 through N−1 in ascending order and re-orders the given set of numbers. The interleaved numbers can then be used as the order of subscripts for the interleaved sequence, O(0) through O(4).

S=01234→O=02413

The first number in the source sequence, 0, is the first number in the interleaved sequence. In this particular example, one adds K to 0 so the next number is 2. Adding K again, the next number is 4. The addition continues, modulo N (modulo 5) to produce 1 and then finally 3. After N numbers have been selected in this manner the interleaving process is completed.

As in the preceding example, whenever K is relatively prime with N, i.e., K and N share no common integer factors, there is a simple formula that maps the elements of S onto O. If i is the location of an element in the output file and h gives the location of an element in the source file we have O(i)=S(h), with

h=(i*K)mod N h is in the closed interval [0, N−1]

The equation above specifies where any given element, S(h), of the input file will be placed in the output file, i.e., which element in the O array it will become (provided that K is relatively prime with N).

In the case where K is not relatively prime with N the above interleaving will select only a subset of the numbers in [0, N−1]. That is, after iterating the procedure N times it is possible for the foregoing procedure to select some elements more than once and to miss other elements. In this case it is necessary to skip by K+1 the first time that an element is about to be selected a second time. The first member of O, i.e., 0, always will be the first to be repeated. When this is about to happen, a skip of K+1 must be used instead of K. In subsequent element selections the skip will revert to K unless another repeat selection is encountered in which case the skip will be K+1 once again.

Accordingly, the interleaving in accordance with one embodiment described below handles two possible cases, i.e., K may or may not be relatively prime with N.

Let N=J*K+L (note: K may or may not be relatively prime with N) Given an input sequence S (h) where 0≦h≦N−1 we produce an output sequence of equal length O(i), 0≦i≦N−1, in the following manner.

Assign O(0)=S(0)

For the sequence i=1 to i=N−1

Compute h=(i*K)modN,

Store h in an array H

If h is not already a member of H then

O(i)=S(h) where h=(i*K)modN

If h is already a member of H then

O(i)=S(h) where h=(i*K)modN+1

Although one interleaving process is described above, other interleaving processes are possible. For example, interleaving in accordance with another embodiment of the present invention is as follows:

BB<-0 [Initialize BB to 0]

O(0)<-S(0)

For the sequence i=1 to i=N−1

Make h equal to (i*K+BB)mod N

If h=BB, then add 1 to BB and add 1 to h.

O(i)<-S(h)

This calculation makes use of the fact that the first element that could possibly be repeated is S(0). If such a repeat is avoided by using S(1) instead, then S(1) must necessarily be the next element at risk of being repeated (and so on). By initializing a constant (arbitrarily called BB above) to 0 and incrementing that constant whenever the algorithm avoids repeating an element, the constant can be used in the calculation of h.

One property of the interleaved sequence obtained by using an interleaving process in accordance with the present invention is the following: Given an element W in the interleaved sequence, there is a neighborhood of size R, where R equals at least J−2, around W within which no element is within K of W. This is most clearly illustrated by an example.

In this example we choose K=3, J=5 and L=1 so that N=J*K+L=16. We let S={0 1 2 3 4 5 6 7 8 9 A B C D E F}.

Following either of the interleaving processes described above, the interleaved or output sequence is O={0 3 6 9 (C F 2 5 8 B E 1 4) 7 A D}

Upon examination of the elements in the neighborhood of a given element of O, for example W=8, it is observed that W is in the middle of a neighborhood of size R=J−1=4, within which all elements are at least K different from W. This is true for all elements in the interleaved sequence O.

A general proof of this property of the interleaved sequence O follows:

N=J*K+L where J, K, and L are whole numbers with J and K greater than 1; and where L is a non-negative integer less than J and less than K.

W is in the closed interval [0, N−1]

Q is in the closed interval [1, J−2].

If W+Q*K<N, then (W+Q*K)mod N is equal to W+Q*K,

If W+Q*K is greater than or equal to N, then

(W+Q*K)mod N=W+Q*K−N=W+(Q−J)*K−L

In that event, W is at least K+L larger than (W+Q*K) mod N.

This means that (W+Q*K) mod N always differs from W by at least K. That is to say, after N has been chosen, the present invention described herein assures that each element of the output sequence is surrounded by a range of 2*R elements that were all at least K spaces from W in the original sequence.

Another property of the interleaving in accordance with the present invention is that N=J*K+L allows one to interleave sequences of any length as long as N>4.

The properties of the interleaved sequences proven in the foregoing discussion also may be visualized geometrically. The geometric visualization is a representation of the sequence elements on a two-dimensional grid. The horizontal grid location is given by the location of the element in the input sequence S and the vertical grid location is the new, i.e., the interleaved location of the element in the output sequence O. The distance between any two elements in S is simply the number of columns between the elements; the distance between two elements in O is given by the number of rows that separate the two elements.

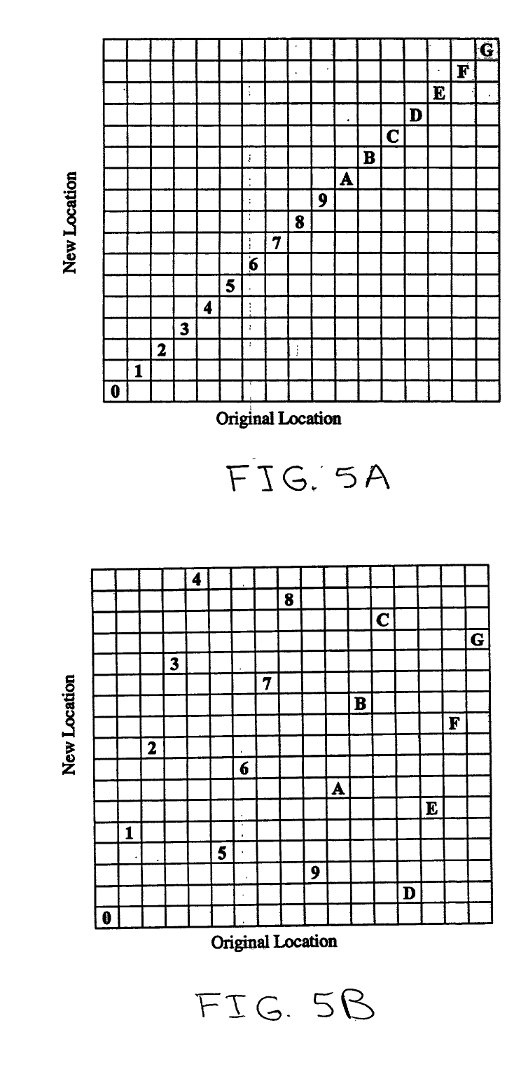

This visualization is illustrated with an example; it is chosen to make J=4, K=4, L=1 so that N=J+K+L=17. Referring to FIG. 5A, a graph of the non-interleaved data is illustrated. The non-interleaved data obviously fall on the diagonal since each element maintains its initial distance from each other element. For example, 6 remains within one row of 5 and 7, and within two rows of 4 and 8.

Referring to FIG. 5B, a graphical representation of the interleaved data is illustrated. If, for example, one examines the neighborhood of 6 in FIG. 5b, the graph shows that 6 is now 4 elements away (the number of rows) from both 5 and 7. Also note that the elements that are adjacent to 6 in 0, i.e., 2 and A were each initially 4 spaces away from 6.

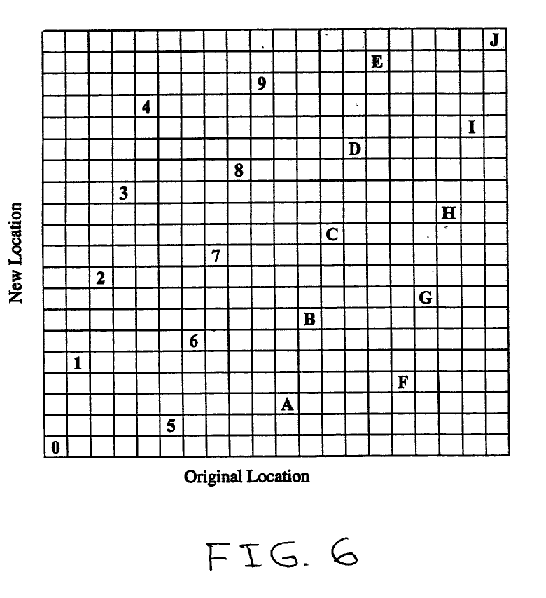

An example to illustrate the procedure when K and N are not relatively prime requiring an occasional skip of K+1 is illustrated below. In this particular example, J=4, K=4, L=0 so that N=J*K+L=16. Referring to FIG. 6, a graph of the interleaved data for J=4, K=4, and L=0 is shown. As this graph illustrates, skips are required every 4th element. In this particular example, 1 must be added to the skip (K→K+1) every 4^{th} element.

As these examples illustrate, one of the attributes of interleaving in accordance with the present invention is that every element is moved equally far from the initially nearby elements. The geometric interpretation of this principle is simply that the elements are distributed on a regular grid in our visualization.

Interleaving in accordance with yet another embodiment is illustrated below. Choose numbers J, K, and L such that J>1, K>1, L is non-negative, L is less than J and less than K, and B is a counting index that is initially set to 0 in the interleaving process. B is also initially set to 0 in the de-interleaving process. N is the total number of elements to be interleaved and is given in terms of J, K, and L by the usual formula N=J*K+L.

The following is an example of how to implement the algorithm.

$$\underline{Repeat while B < K}$$

$$Repeat while h < N$$

$$O [ i ] < -- S [ h ]$$

$$h < -- h + K \\ \underline{i < -- i + 1} \\ B < -- B + 1 \\ \underline{h = B} \\ End of program$$

Referring back to FIG. 3, in step 35 the interleaved sequence is divided into packets for transmission. In step 36 the interleaved sequence is transmitted by one of the communication nodes 12(1) or 12(2) via the network 14. In step 37 the interleaved sequence is received by the other one of communication nodes 12(1) or 12(2). In step 38, the received packets are assembled into the interleaved sequence. A variety of different communication protocols and methods can be used to transmit the interleaved sequence. During the transmission part of the information in the interleaved sequence may be lost or damaged and as discussed with reference to FIG. 2 there is a higher probability that will occur in adjacent packets. With the present invention, these errors will be dispersed through the interleaved sequence.

In step 39, the communication node 12(1) or 12(2) which received the interleaved sequence will de-interleave the interleaved sequence to recover the original sequence. De-interleaving the interleaved sequence in accordance with one embodiment is as follows:

BB<-[Initialize BB to zero]

D(0)<-O(0)

For the sequence i=1 to i=N−1

Make h equal to (i*K+BB)mod N

If h=BB, then add 1 to BB and add 1 to h.

D(h)<-O(i)

The communication PC 12(1) or 12(2) which de-interleaves checks for repeats wherever they may occur.

The following is the meta-language description of the de-interleaving in accordance with another embodiment:

B<-0

i<-B

h<-0

Repeat while h<N

$$\underline{m < -- 0 ( m is a counting index )}$$

$$Repeat while i < N$$

$$If m < L , C < -- 1 ; Else C < -- 0$$

$$D [ h ] < -- O [ i ]$$

$$h < -- h + 1$$

$$m < -- m + 1$$

$$\underline{i < -- i + J + C}$$

$$B < -- B + 1$$

$$\underline{i = B}$$

$$End$$

In step 40, the communication node 12(1) or 12(2) which de-interleaved the interleaved sequence to the original sequence may compensate for the loss of small segments of sequential data, specifically in the case of audio, by interpolation or other correction techniques or methods. In step 42, the communication node 12(1) or 12(2) which recovered and corrected the original sequence from the interleaved sequence may provide the original sequence to a user and/or may store the original sequence in a memory storage device, such as memory 18(1) or 18(2). In step 44, the method in accordance with one embodiment of the present invention ends.

The interleaving algorithm is general and may be applied to data at the level of the bit, byte, or group of bytes depending upon the specific application. Variations of the implementation have been proposed for one-dimensional data, such as audio, and two-dimensional video data. The method removes the error compensation strategy from the network traffic to become an element of the signal processing at the sending and receiving devices and allows the use of a minimal Internet communication protocol, such as UDP/IP. The interleaving algorithm could also form the basis of a new more general Internet protocol that permits latency sensitive applications. The technique is applicable to wireless PDA devices in an IP telephony mode, to two-way tele-medical imaging, and synchronous distance learning and musical collaborations. It would also benefit one-way streaming audio for Internet radio, because of reduced transmission overhead protocol and, hence, bandwidth.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. A method for communications using interleaving, the method comprising:
interleaving elements of data in a source sequence to form an interleaved sequence, wherein adjacent elements in the interleaved sequence originally were separated by a first number of elements in the source sequence and originally adjacent elements in the source sequence are separated by at least a second number of elements in the interleaved sequence; and
transmitting the interleaved sequence of the elements of the data.

2. The method as set forth in claim 1 further comprising;
receiving the interleaved sequence; and
de-interleaving the elements of data in the interleaved sequence back to the source sequence for the elements of the data.

3. The method as set forth in claim 2 further comprising interpolating for any error in any of the elements of the data in the original sequence after the de-interleaving.

4. The method as set forth in claim 1 wherein the interleaving further comprises O(i)=S(h) where h=(i*K)modN, if h is not already a member of H and O(i)=S(h) where h=(i*K)modN+1 if h is already a member of H, where S denotes the source sequence, O the interleaved sequence and K is a whole number greater than 1.

5. The method as set forth in claim 1 wherein the interleaving further comprises initializing an index number BB to be 0 and then for the sequence i=1 to i=N−1, O(i)=S(h) where h=(i*K+BB)mod N and if h=BB, then add 1 to BB and add 1 to h.

6. The method as set forth in claim 1 wherein the de-interleaving further comprises initializing BB to be 0 and then for the sequence i=1 to i=N−1, D(h)=0(i) where h=(i*K+BB)mod N and if h=BB, then add 1 to BB and add 1 to h.

7. A computer readable medium having stored thereon instructions for communications using interleaving which when executed by a processor, causes the processor to perform the steps of:
interleaving elements of data in a source sequence to form an interleaved sequence, wherein adjacent elements in the interleaved sequence originally were separated by a first number of elements in the source sequence and originally adjacent elements in the source sequence are separated by at least a second number of elements in the interleaved sequence; and
transmitting the interleaved sequence of the elements of the data.

8. The computer readable medium as set forth in claim 7 further comprising;
receiving the interleaved sequence; and
de-interleaving the elements of data in the interleaved sequence back to the source sequence for the elements of the data.

9. The computer readable medium as set forth in claim 8 further comprising interpolating for any error in any of the elements of the data in the original sequence after the de-interleaving.

10. The computer readable medium as set forth in claim 7 wherein the interleaving further comprises O(i)=S(h) where h=(i*K)modN, if h is not already a member of H and O(i)=S(h) where h=(i*K)modN +1 if h is already a member of H, where S denotes the source sequence, O the interleaved sequence and K is a whole number greater than 1.

11. The computer readable medium as set forth in claim 7 wherein the interleaving further comprises initializing BB to be 0 and then for the sequence i=1 to 1=N−1, O(i)=S(h) where h=(i*K+BB)mod N and if h=BB, then add 1 to BB and add 1 to h.

12. The computer readable medium as set forth in claim 7 wherein the de-interleaving further comprises initializing BB to be 0 and then for the sequence i=1 to i=N−1, D(h)=0(i) where h=(i*K+BB)mod N and if h BB, then add 1 to BB and add 1 to h.

13. A system for communications using interleaving, the system comprising:
a first interleaving processing system that interleaves elements of data in a source sequence to form an interleaved sequence, wherein adjacent elements in the interleaved sequence originally were separated by a first number of elements in the source sequence and originally adjacent elements in the source sequence are separated by at least a second number of elements in the interleaved sequence; and
a first communication system that transmits the interleaved sequence of the elements of the data.

14. The system as set forth in claim 13 further comprising:
a second communication system that receives the interleaved sequence; and
a second interleaving processing system that de-interleaves the elements of data in the interleaved sequence back to the source sequence for the elements of the data.

15. The system as set forth in claim 14 wherein the second interleaving processing system interpolates for any error in any of the elements of the data in the original sequence after the de-interleaving.

16. The system as set forth in claim 13 wherein the first interleaving processing system interleaves elements of data in a source sequence so that O(i)=S(h) where h=(i*K)modN, if h is not already a member of H and O(i)=S(h) where h=(i*K)modN +1 if h is already a member of H, where S denotes the source sequence, O the interleaved sequence and K is a whole number greater than 1.

17. The system as set forth in claim 13 wherein the first interleaving processing system interleaves elements of data in a source sequence by initializing BB to be 0 and then for the sequence i=1 to 1=N−1, O(i)=S(h) where h=(i*K+BB)mod N and if h=BB, then add 1 to BB and add 1 to h.

18. The system as set forth in claim 13 wherein the second interleaving processing system de-interleaves elements of data in a source sequence by initializing BB to be 0 and then for the sequence i=1 to i=N−1, D(h)=O(i) where h=(i*K+BB)mod N and if h=BB, then add 1 to BB and add 1 to h.
